(19) United States
(12) Patent Application Publication
(10) Pub. No.: US 2009/0308298 A1
(43) Pub. Date: Dec. 17, 2009

(54) Steering device for boats

(75) Inventor: Giorgio Gai, Genova (IT)

Correspondence Address: Themis Law, 7660 Fay Ave Ste H-535, La Jolla, CA, 92037, US

(73) Assignee: ULTRAFLEX SPA, Casella (Genova) (IT)

(21) Appl. No.: 12/064,028

(22) PCT Filed: Sep. 29, 2006
(86) PCT No.: PCT/EP2006/066937

§ 371 Date: May 22, 2008

(30) Foreign Application Priority Data
Nov. 4, 2005 (IT) SV2005A000034

(51) Int. Cl. B63H 25/42; B63H 25/00; B63H 5/14; H01H 47/00

(52) U.S. Cl. 114/151; 114/144 R

(57) ABSTRACT

Steering device for boats comprising a through channel passing through the hull of a boat from side to side under the water line, inside which channel there is provided at least a propeller operated by a motor, wherein said motor is housed inside said channel and the propeller is mounted directly on the axle of said motor or by means of a drive placed between said axle of the motor and said propeller.

### FIELD

The present invention relates to a steering device for boats that includes a through channel passing through the hull of the boat from side to side under the water line, inside which channel there is provided at least a propeller operated by a motor.

### BACKGROUND

Steering devices for boats are known and widely used. While these devices satisfactorily serve their function, they still suffer from certain drawbacks.

In prior art steering devices, the motor operating the propeller is housed inside the hull and the motion is transmitted from the motor to the propeller by driving means, such as for example chains, belts or mechanical transmissions. Consequently, devices according to prior art must be provided with structures for transmitting the motion from the motor to the propeller and moreover with equipment for protecting driving systems against the corrosive action due to water agents. Propellers are obviously placed under the water line of the boat and so means transmitting the motion from the motor to the propeller must be suitably protected against the action of sea water.

In prior art devices, there is a system composed of a flange for coupling the motor on the channel, and a watertight box for housing an orthogonal gear or parallel positive belt drive system. This complicated transmitting system of the drive, in addition to having a high cost, causes a decrease in efficiency with respect to a direct drive.

In addition, systems according to the prior art are difficult to install in small boats, because of the size of the motor placed perpendicularly or parallel with respect to the duct, causing restrictions of spaces inside the boat.

A further drawback of prior art devices is related to the fact that they have a difficult maintenance. The need for a frequent maintenance is obvious if the potentially corrosive environment, inside which the device works, is considered. It is therefore necessary to have a device, whose various parts can be easily reached. In prior art devices the presence of means for transmitting the motion, the presence of the motor inside the hull and of the propeller outside of the hull, leads to a difficult accessibility of various components of the device that must be reached from different regions of the boat, actually making the maintenance difficult, long-lasting and expensive.

Also, this drawback is noticed to a greater extent when the steering device is intended to be installed in small boats, since the maintenance cost is such that the installation thereof is avoided. A further drawback of devices according to prior art is related to the fact that it is not simple to install a steering device on an already made boat, since it is necessary to integrate commands and controls of the device with commands and controls and controlling lines that are already present on the boat.

There is a further drawback for devices according to prior art: with the device being in use, it is possible to have a situation of an undesired and extended operation of the device, typically operated by relais, a condition that is known to the person skilled in the art as “gluing” of relay contacts, mainly due to the passage of current through contacts, the current being very high such that it can interfere with the breaking of the contact, keeping the circuit in the on condition and the motor in use. Steering devices are planned to be usually operated for short time periods, and a condition like the one described above causes the electric motor of the device to be overheated, leading not only to damages thereof, but also to dangerous fire situations on board.

### SUMMARY

The aim of the present invention is to provide a steering device for boats that overcomes drawbacks of known steering device in a simple and inexpensive way. The invention achieves the above aims by providing a steering device for boats comprising at least: a through channel passing through the hull from side to side under the water line, inside which channel there is provided at least a propeller operated by a motor, wherein said motor is housed inside said channel and the propeller is mounted directly on the axle of said motor or by means of a drive placed between said axle of the motor and said propeller.

Thus advantageously drawbacks of prior art are overcome. The steering device according to the present invention is easy to assemble, has a high efficiency, a simple maintenance and a low cost.

The presence of a motor directly connected to a propeller in the through channel connecting the two sides of the boat advantageously enables the elimination of expensive components for transmitting the motion from the motor to the propeller, actually making the device very simple also during the manufacturing process and, moreover, making the device easy to be installed, since it is not provided with means necessary to steering devices according to prior art for transmitting the motion from an inboard motor to a propeller placed outside the boat.

According to an advantageous characteristic, the device according to the present invention provides said motor to be housed in a watertight box, and seals are provided in order to make for a watertight seal between said drive and/or said axle of the propeller and said watertight box. Thus, the motor is housed inside the channel but is protected against the corrosive action of sea environment by a watertight box, simple and inexpensive and substantially light, above all if compared with means for transmitting the motion used in the prior art. Moreover, advantageously, the device according to the present invention provides for a fast and inexpensive maintenance, since both the motor and the propeller, in addition to not having long and heavily mechanical transmissions for transmitting the motion, are housed in the same region of the boat and so can be accessed from the same region of the boat. Therefore, it will be sufficient to access to the through channel in order to have access to the maintenance of the entire device. Moreover, a device according to the present invention, since the motor is directly connected to the propeller/propellers has a high mechanical efficiency, and since it is not necessary to have a long kinematic chain for transmitting the motion from the motor to the propeller, the motor and the propeller are operatively connected, resulting in an high mechanical efficiency.

Moreover, the presence of a motor directly connected to the propeller makes for an easy installation on small boats, due to the overall dimensions of the motor that is no longer placed perpendicularly or parallel with respect to the duct, thereby not causing space restrictions inside the boat.

According to a further advantageous characteristic of the present invention, it is possible to provide for the direct mounting of an electric motor, thereby having a low cost, a very reduced maintenance and a known strength, further reducing the need for maintenance, or making maintenance necessary only for the propeller, which for example will have to be cleaned at regular intervals.

The presence of an electric motor is actually possible in the present invention because the propeller and the motor are substantially free or almost free from mechanical transmissions, leading to a reduction in frictions and allowing for the use of an electric motor instead of a hydraulic motor. However, it is possible to mount a hydraulic motor instead of the electric motor, above all in very heavy boats.

Moreover, the presence of the motor outside of the boat helps in avoiding or reducing the danger of fire for the motor, even if a fire would take place starting from the motor, but still that would not be inside the hull of the boat.

According to an embodiment of the present invention, it is possible to mount two propellers connected to the same motor on the two sides of the watertight box housing the motor, or as an alternative embodiment, to mount inside the same channel two separated and equal boxes having two motors and two propellers, according to the requirements of the boat owner. Thus, the present solution provides for a kind of modular mounting, that can be chosen according to different manufacturing and steering power requirements.

It is possible to provide the watertight box, to be mounted inside the channel, with a mechanical support called herein fastening projection, that according to a preferred embodiment can be hollow and house feeding lines of the motor. Thus, inside the channel there are no cables or moving lines, advantageously increasing the strength and safety of the device.

Moreover, the watertight box housing the motor may be provided with a overall dimensions substantially coinciding with the dimensions of the motor, or at the most, slightly greater, causing the box inside the channel to be hydrodynamically neutral, i.e. not producing undesired turbulences in the water flow travelling inside the channel due to the propeller. In order to further decrease turbulences, in a preferred embodiment, said fastening projection and said watertight box have an outer cylindrical profile, known to have optimal lift and strength regarding the avoidance of turbulences.

A further object of the present invention is a system for commanding a steering device for boats that includes at least control/command electronics, a power relay operatively connecting the electric motor of the steering device with an electric supplying source, for example an electric battery or the like, and at least a control/command panel for said steering device, wherein said control/command electronics receive from said control/command panel at least a command signal for the corresponding operation of said device, by a connection of the CAN bus type or the like, and wherein said command/control electronics operates said power relay in a manner corresponding to said command signal, in order to close at least an electrical contact feeding said motor of said steering device.

Particularly advantageously, there is provided a power relay providing for an operation in safety condition, i.e. the two coils of the relay, when in use, are alternatively energized by the command/control electronics, in order to close the contacts of a part of the electrical circuit and to rotate the electric motor of the steering device in one or in the other direction, due to the passage of current in one branch or in the other one of the circuit. As mentioned previously, in prior art devices it is possible to have a “gluing” action, i.e. one of the two contacts of the coils, in spite of a disenergization of the coil, remains glued in place, i.e. closed, and it continues to leave the current passing in the corresponding branch, causing an undesired and extended operation of the motor, with the danger of overheating and fire. The control system according to the present invention provides for an operation in safety condition, which operation in safety condition provides that if one of the two relay contacts remains closed, i.e. “glued”, the other contact is closed in order to cause the circuit to be in an equipotential condition, turning off the power supply to the electric motor. The detection of the undesired closing condition of one of the two contacts, or gluing condition, is preferably carried out by the command/control electronics following the detection of an undesired current passage from the supply source, detected by means for detecting a current passage, and/or following the detection of an undesired or anomalous increase in the temperature of the relay and/or motor, detected by means measuring temperature, and/or following the detection of an anomalous operating condition detected by proper means sensing operating conditions. An anomalous operating condition is meant to indicate any undesired operating condition, for example, when there is no operating command and nevertheless the motor is still fed, or when there is a command disenergizing the motor and the motor is still fed.

Further characteristics and improvements are recited in the claims.

### BRIEF DESCRIPTION OF THE DRAWINGS

Characteristics of the invention and advantages deriving therefrom will be clearer from the following detailed description of the annexed figures, wherein:

FIG. 1 is plan side view of a device according to the present invention;

FIG. 2 is a perspective detail view of a device according to the present invention;

FIG. 3 is a side view of an alternative embodiment of a device according to the present invention;

FIG. 4 is a side view of an alternative embodiment of a device according to the present invention;

FIG. 5 is a side view of a second alternative embodiment of a device according to the present invention;

FIG. 6 is a side view of a third alternative embodiment of a device according to the present invention;

FIGS. 7 and 8 are a side views of possible positioning regions of a device according to the present invention;

FIG. 9 illustrates an alternative embodiment of the present invention;

FIG. 10 is a diagram of a control system for a steering device according to the present invention;

FIG. 11 is the relay of a system according to the present invention in a first regular operating condition;

FIG. 12 is the relay of a system according to the present invention in a second regular operating condition;

FIG. 13 is the relay of a system according to the present invention in a second not regular operating condition;

FIG. 14 is a diagram of preferred characteristics of a motor for a device according to the present invention; and

FIG. 15 is a command station for a device according to the present invention.

### DETAILED DESCRIPTION

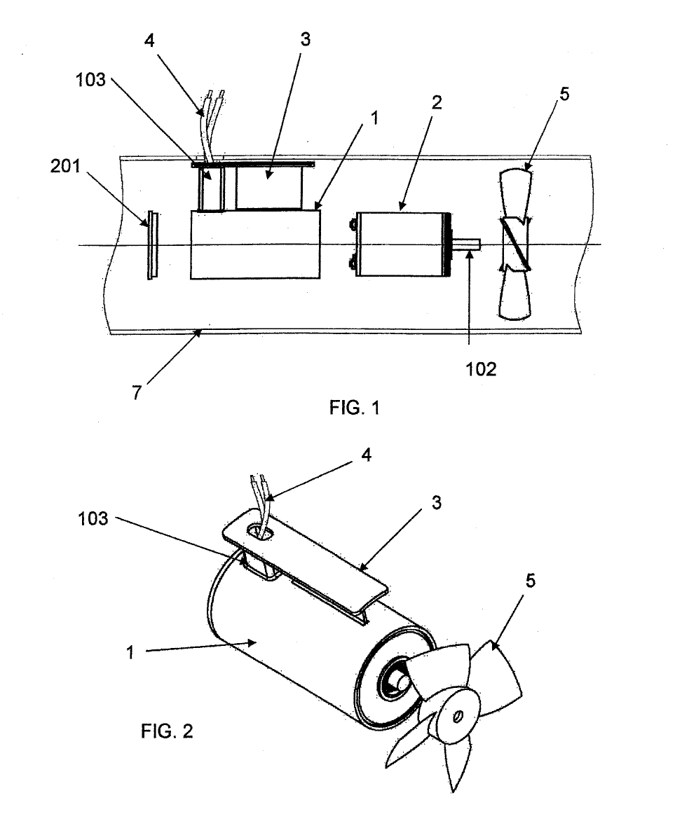

FIG. 1 depicts, in a longitudinally exploded condition, a first embodiment of the device according to the present invention comprising a through channel 7 passing through the hull of the boat from side to side under the water line, inside which channel 7 there is provided at least a propeller 5 driven by a motor 2. The motor 2 is housed inside said channel 7 and the propeller 5 is mounted directly on the axle 102 of said motor or by means of a drive placed between said axle of the motor 2 and said propeller 5.

It can be noted that the motor 2 is housed inside a watertight box 1 and that seals 101 are provided, as shown for example in FIG. 4, in order to obtain the watertight effect between said drive 102 and said watertight box 1. In FIG. 2 there is shown the embodiment of FIG. 1 in the assembled condition, thus giving a clear indication of the compactness of the device according to the present invention once it is assembled. Moreover, it can be noted that the watertight box 1 is connected to the boat hull and/or to the wall of said channel 7 by at least a fastening projection 3. The embodiment shown in FIGS. 1 and 2 provides a single propeller 5 having an axle of rotation parallel to the development axis of said channel 7, said axles of rotation 102 being tightly projected from one end of said watertight box 1. In this preferred embodiment, the watertight box 1 has a cylindrical shape and it has a watertight closure 201 at the end opposite to the end associated to said drive axle 102.

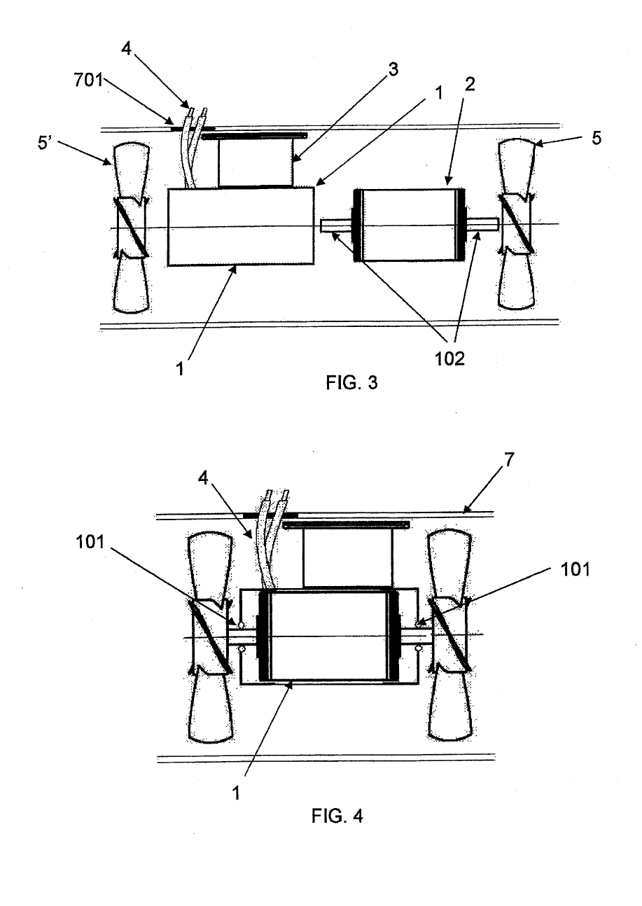

In FIGS. 3 and 4 there is shown an alternative embodiment of the device according to the present invention, wherein there are provided two propellers 5, 5′ having axles 102, 102′ parallel to the development axis of said channel 7, said axles of rotation 102, 102′ being tightly projected from the two ends of said watertight box 1.

Advantageously, thus, the two propellers are arranged in the same channel increasing the efficiency and using the same motor for operating both of them. In FIG. 4 it is possible to note also in this embodiment how overall dimensions are highly reduced due to the single watertight box 1.

In FIGS. 1 and 2 it is possible to note that advantageously the projection 3 fastening said watertight box to the wall of the through channel defines a tubular duct 103 housing feeding lines 4 of the motor 2.

The tubular duct 103 is tightly connected to the hull and/or to the watertight box 1.

In figures it is possible to note that said motor 2 is an electric motor and the feeding line 4 is composed of electrical cables feeding said electric motor 2.

It is however possible for said electrical cables to be watertight ones and so to be placed outside the tubular duct 103, such as shown for example in FIGS. 3 and 4. Thus advantageously the structure becomes even lighter and more economical.

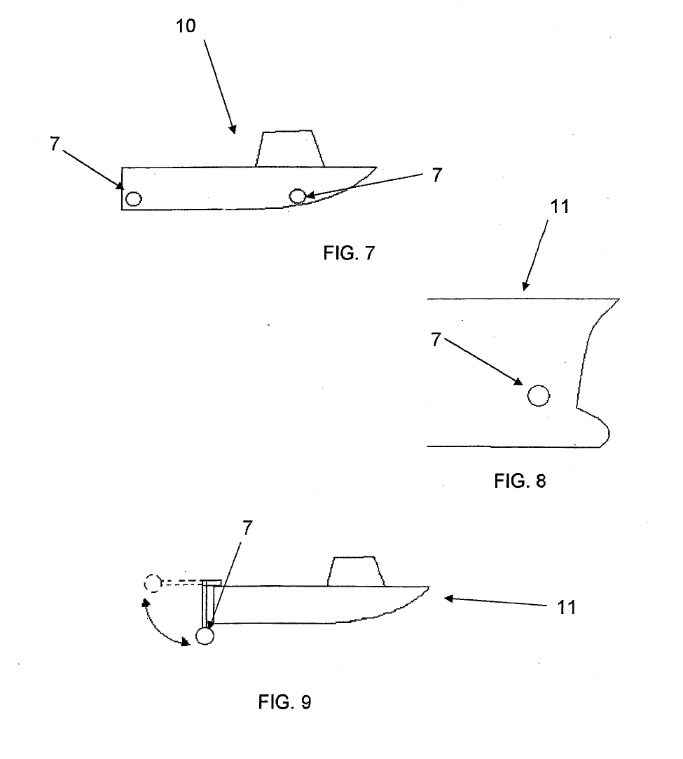

As can be noted in FIGS. 7 and 8, said channel 7 is arranged transversally with respect to the longitudinal axis of the hull and/or passing through said hull, and preferably at the stem and/or stern regions of the boat.

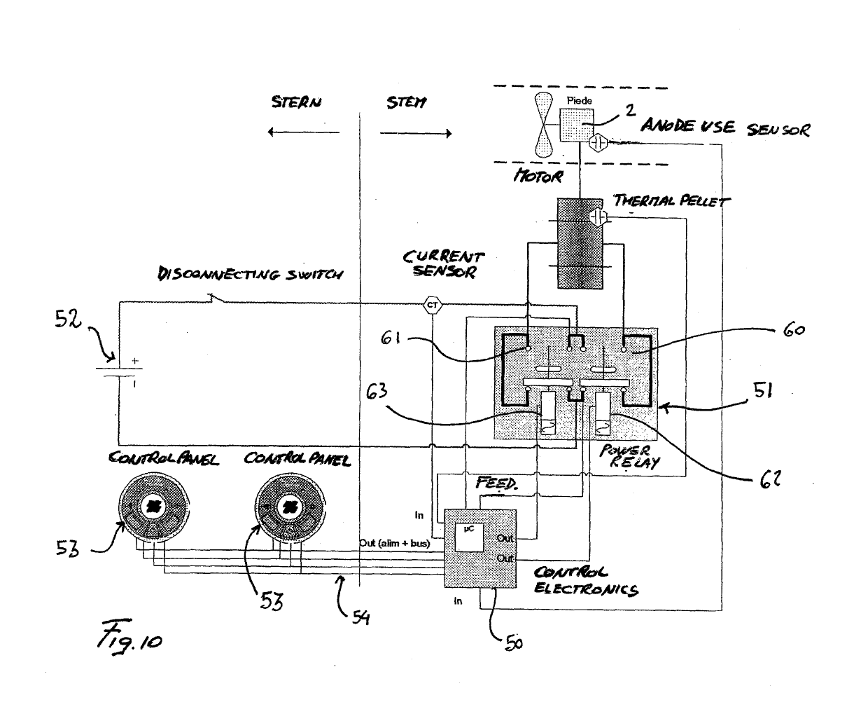

Alternatively, such as shown in FIG. 9, the present invention in an alternative embodiment provides the watertight box to be mounted inside a duct 7, that is placed transversally with respect to the longitudinal axis of the hull and it is placed outside of the hull, for example such as shown by an arm hinged at the stern of the hull. The duct 7, made for example by means of a tube stub, composes the channel wherein at least a propeller 5 is provided operated by a motor 2 housed inside said channel 7 and the propeller is mounted directly to the axle of said motor or by a drive placed between said axle 102 of the motor 2 and said propeller 5, similarly to what described and claimed for carrying out the invention inside the hull.

As it can be noted in FIG. 3, the fastening projection 3 at least partially has a T-like transverse section, in order to limit the weight and cost thereof, and moreover it has a width that is smaller than the diameter of the watertight box 1.

Advantageously, in order to have lesser turbulences and a better hydrodynamic efficiency, the through channel 7 is cylindrical, the watertight box 1 is cylindrical and is kept at a coaxial position with respect to the through channel 7 by the fastening projection 3, which fastening projection is radially oriented. Still in order to keep low the level of turbulences and the overall dimensions of the device, as well as its weight, the watertight box is composed of a tight tubular element 301 having an inner transversal section with shape and size substantially equal to the transversal section of the motor and with an axial length slightly greater than the one of the motor body, whereas tubular element 301 is tightly closed at both end sides by an end wall 201 and seal 101. On the side where the motor shaft comes out, the end portion 201 is removable and it has a through opening, for the motor shaft 102, and rotation tight means between said opening and said shaft.

In a variant embodiment, the watertight box is composed of a cup-like element comprising the tubular body 301 and the end side 201 opposite to the one where the motor shaft comes out, which cup-like element is divided into two half-shells along a diametral or meridian, longitudinal section plane, which half-shells can be tightly fastened one with the other, and the box has an end wall that is removable and tightly fastenable at the end side associated to the motor shaft.

A further variant provides half-shells to integrally comprise both the covering and end wall portions on the two ends, the division transversal plane passing by the opening of the motor shaft.

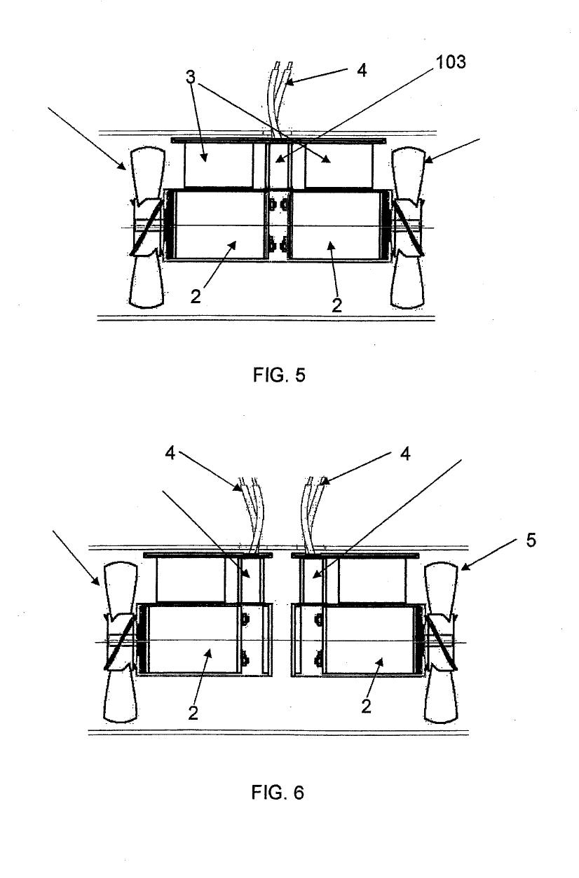

In FIGS. 5 and 6, there are shown two other preferred embodiments of the device according to the present invention. Particularly, FIG. 5 shows a steering device having a single watertight box 1 enclosing inside it two motors 2, each of which is associated to a corresponding propeller 5, 5′ having in common a single tubular duct 103 made in the single post 3 for passing feeding lines 4 common to the two motors. Thus, a device having a kind of modularity in its manufacturing is obtained, since some parts are in common, advantageously causing the device to have a lower weight.

In FIG. 6, there is shown a further advantageous embodiment, wherein two single devices are provided one near the other such as for example the one shown in FIG. 1. Thus the manufacturing and the assembling of devices on the boat can actually occur in a modular manner, for example by firstly mounting a single device and subsequently, if necessary, a second device if the presence of a single device does not achieve the desired steering effect.

Referring to shown embodiments, the person skilled in the art can immediately appreciates advantages of the device according to the invention.

The combination of a watertight box 1 and of an electric motor allows a very easy and inexpensive manufacturing that makes for an easy replacement of the motor and guarantees a tight closure. In the cup-like variant with removable wall on the side of the shaft, the motor is simply inserted in the cup-like part, whose inner room has a size corresponding to or slightly greater than the outer overall dimension of the motor. The end wall is therefore applied with seals between it and the cup-like part between said end wall and the shaft. The locking action may occur by axial or radial bolts or screws.

As an alternative, the end wall may be provided with a threaded axial extension that can be screwed in a threaded ending portion and the seal may be provided between the perimetral band of the end wall and the end edge of the cup-like element.

In the variant with the two half-shells, the seal is provided along the contact edges of the two half-shells.

According to a variant embodiment, the device of the present invention, as described previously or with the only possible change of the projection 3, may be a device outside the hull, such as shown in FIG. 9. Particularly, means fastening to the hull may be composed of means allowing the device to move from an idle position above the water line to an operating position under the water line.

Advantageously, said supporting means are composed of the projection 3 made like an articulated arm or pivotally fastened to the hull, such as shown in FIG. 9. According to a further variant embodiment, the device of the present invention may provide for a tube, or the like, creating a channel inside which there is mounted a watertight box enclosing a motor, to which at least a propeller is applied, such as described above, and which tube is mounted outside of the hull of the boat, for example by means of a pivotal or articulated arm, that can move the device from an idle position above the water line to an operating position under the water line. Alternatively to or in combination with the outer variant, it is possible to provide the device of the present invention configured to be mounted directly under the boat keel, so it can be applied also to already made boats when it is not possible or advisable to bore the hull keel under the water line for arranging the through channel.

A further feature of the present invention is shown in FIG. 10, which depicts a control system for a steering device for boats comprising at least a control/command electronics 50, a power relay 51 operatively connected between the electric motor 2 of the steering device, and an electric supply source 52, for example an electric battery or the like, and at least a control/command panel 53 for said steering device, wherein said control/command electronics 50 receives at least a command signal from said control/command panel 53 for the corresponding operation of said device, preferably but not limited to by a connection 54 of the CAN bus type or the like, and wherein said command/control electronics 50 operates said power relay 51 in a manner corresponding to said command signal, in order to close at least an electrical contact 60, 61 feeding said motor 2 of said steering device. Particularly advantageously, there is provided a power relay 51 providing for an operation in safety condition, i.e. the two coils 62, 63 of the relay when in use are alternatively energized by the command/control electronics 50, in order to close contacts of a part of the electrical circuit and to rotate the electric motor 2 of the steering device in one or in the other direction, due to the passage of current in one branch or in the other one of the circuit.

In prior art devices, it is possible to have a “gluing” action, i.e. one of the two contacts 60, 61 connected to coils 62, 63, and in spite of a disenergization of the coil, the corresponding contact 60 or 61 remains glued in place, i.e. in the on circuit condition, and it continues to leave the current passing in the corresponding branch, causing an undesired and extended operation of the motor, with the danger of overheating and fire.

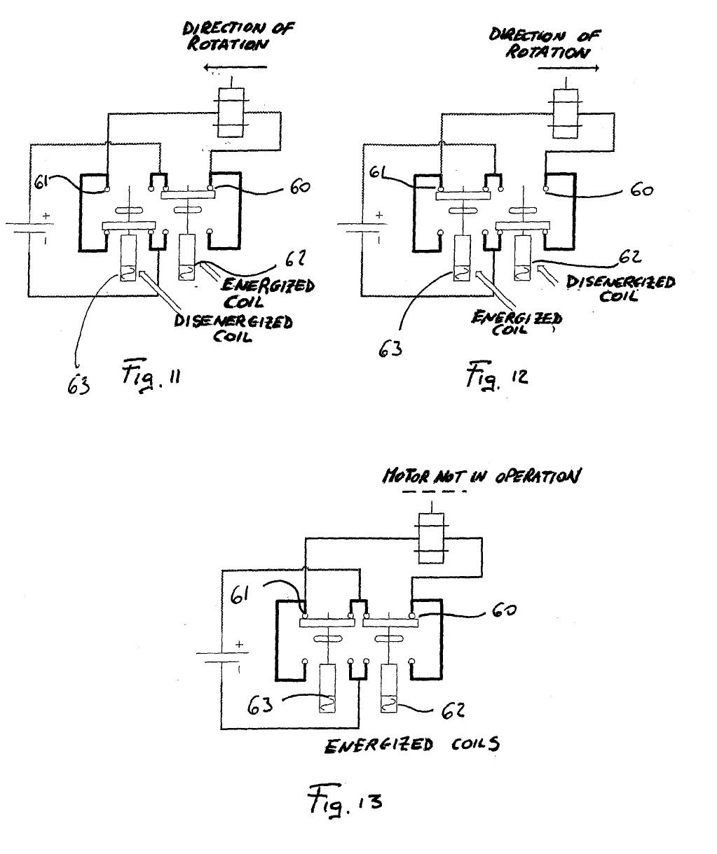

With reference to FIGS. 11 and 12, there are shown the normal operation conditions of the relay with the rotation in one direction or in the other direction of the electric motor.

Particularly in FIG. 11, there is shown a first case of regular operation wherein the coil 63 is not energized and the corresponding contact 61 is in the off circuit position, while the coil 62 is energized by the command and control gearcase and the corresponding contact 60 makes an on circuit condition allowing to feed one of the two circuit branches and allowing the motor to rotate, which rotates in one direction. As an alternative with regards to the rotation of the motor in the other direction, FIG. 12 shows a situation wherein the coil 62 is not energized and the corresponding contact 60 is in off circuit position, while the coil 63 is energized by the command and control gearcase and the corresponding contact 61 makes an on circuit condition allowing to feed one of the two branches of the circuit and allowing the motor to rotate, which rotates in the direction opposite to the rotation direction of the motor fed according to the situation of FIG. 11.

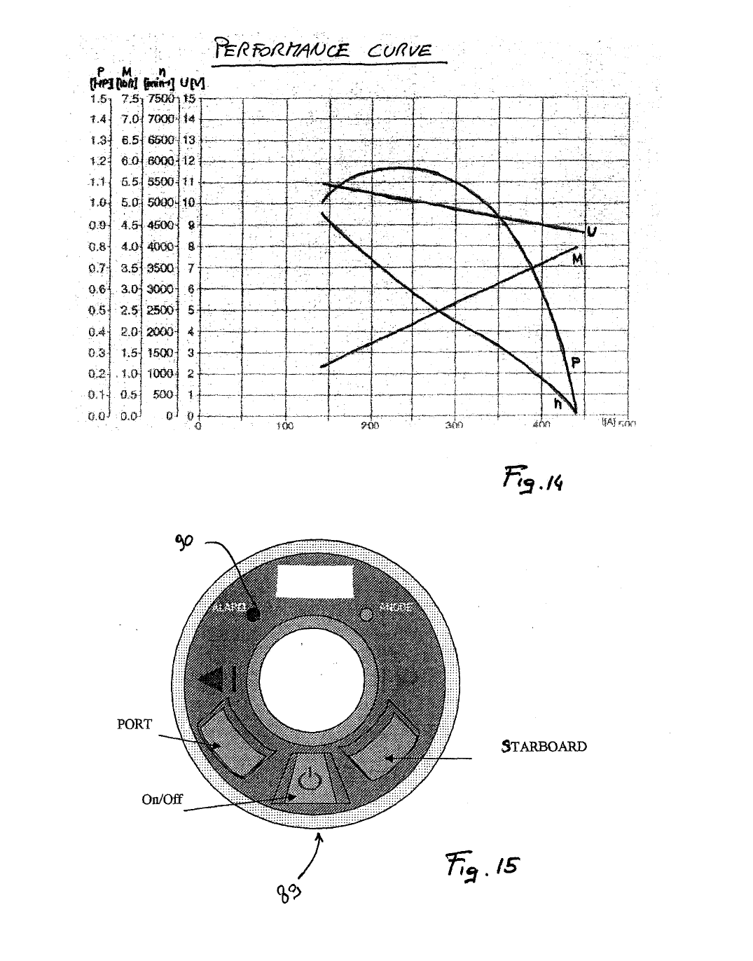

Since the current involved is very high, it is possible that by simply disenergizing the coil the contact remains glued and the current goes on passing, with the undesired results described above. The control system according to the present invention provides an operation in safety condition, which operation in safety condition provides that if one of the two relay contacts remains closed, i.e. “glued”, the other contact is closed in order to lead the circuit in an equipotential condition such as shown in FIG. 13, therefore turning off power supply to the electric motor.

In FIG. 13 there is shown an operation situation wherein one of the two contacts 60 or 61 remained glued in the closed, undesired condition, and, in order to avoid the motor to become overheated and possibly problems when driving the boat, the command gearcase, once the not desired operation of the motor has been detected, i.e. not corresponding to an order inputted by the user, has energized the other relay, or again both of them, in order to close both branches of the circuit and to lead them in an equipotential condition, thus avoiding the current to pass through.

The detection of the undesired closing condition of one of the two contacts, or gluing condition, is preferably carried out by the command/control electronics following the detection of an undesired current passage from the supply source, detected by means for detecting the current passage, and/or following the detection of an undesired or anomalous increase in the temperature of the relay and/or motor, detected by means measuring the temperature, and/or following the detection of an anomalous operating condition detected by proper means sensing operating conditions. Obviously the anomalous operating condition is meant to be any undesired operating condition, for example, when there is no operating command and the motor is still fed, or when there is a command disenergizing the motor and it is still fed.

The control system is particularly advantageous when it is used in combination with a device according to the present invention, providing a device with high safety degree, firstly because it prevents the motor to be overheated, and also because in the case of a malfunction of the system, a possible fire due to an overheated motor would not occur inside the boat, but outside the hull, actually making a device with a very high real safety level. In FIG. 15 there is shown an interface command panel 89 for a device and system according to the present invention. The command panel 89 is advantageously reduced in size and it is easy to use, providing an easy operation and command of the device and providing also a possible alarm signal 90, for example to indicate the intervention of the control system described above, and to inform the user.

In FIG. 14 there is shown a typical diagram for a motor, particularly advantageous if the motor is used as a motor for a device according to the present invention.

A particularly advantageous embodiment with regard to compactness, weight and cost in the case of boats, on which the device and/or the system according to the present invention are mounted, is as follows: boats with a length comprised between 8.5 and 16 meters typically require a thrust force of 55-60 kgf from 8.5 to 13 meters and from 75 to 85 kgf for boats of 13 to 16 meters. The tube inside which the device is mounted is preferably made of plastic reinforced by fiber glass, steel, aluminum, and the propeller is made of plastic material, in order to reduce involved weights.

The motor is of 12V power supplied to the standard supply mains and electric batteries of the boat, and supplies from 07 to 1.5 HP, preferably 1 HP, while the operating current is 150 Ampere and the rotation speed of the motor is 4500 rpm, with a motor weight of 1.5 to 3 kg, preferably 2 kg.

It has been found that a device made according to the above description is particularly advantageous with regard to the reduction in weight and cost, while maintaining an optimal response rapidity and steering effect on the boat where it is mounted.

In FIG. 14, there is shown a performance curve particularly suitable for a motor whose use is particularly advantageous in combination with the device and/or system according to the present invention.

1. A steering device for a boat comprising:
a through channel passing through a hull of the boat from side to side under a water line, a propeller being provided inside the through channel, the propeller being operated by a motor,
wherein said motor is housed inside said through channel, and
wherein the propeller is mounted directly on an axle of said motor or is coupled to the motor by a drive placed between said axle of the motor and said propellers.

2. The steering device according to claim 1 wherein the motor is housed inside a watertight box, and wherein seals provide water tightness between said drive and/or said axle and said watertight box.

3. The steering device according to claim 2 wherein said watertight box is connected to the hull and/or to a wall of said through channel by at least a fastening projection.

4. The steering device according to claim 2, wherein said propeller is a single propeller having an axle of rotation parallel to a longitudinal axis of said through channel, said axle projecting from one end of said watertight box.

5. The steering device according to claim 4, wherein said watertight box has a cylindrical shape and further has a watertight closure at an end opposite to the end from which said axle projects.

6. The steering device according to claim 4, wherein there are provided two propellers having axles parallel to the longitudinal axis of said through channel, said axles projecting from two opposite ends of said watertight box.

7. The steering device according to claim 3 wherein the projection fastening said watertight box to the wall of the through channel defines a tubular duct.

8. The steering device according to claim 7 wherein said tubular duct houses feeding lines for feeding said motor.

9. The steering device according to claim 3 wherein said tubular duct is tightly connected to the hull and/or to the watertight box.

10. The steering device according to claim 8 wherein said motor is an electric motor, and wherein the feeding lines comprise electrical cables feeding said electric motor.

11. The steering device according to claim 10, wherein said electric cables are watertight and/or electrically insulated from an outside environment.

12. The steering device according to claim 3, wherein said through channel is arranged transversally on the hull and/or is passing through said hull in relation to a longitudinal axis of the boat.

13. The steering device according to claim 3, wherein said fastening projection has a transverse section that is T-shaped.

14. The steering device according to claim 3, wherein the fastening projection has a width that is smaller than a diameter of the watertight box.

15. The steering device according to claim 3 wherein the through channel is made as a cylindrical, and wherein the watertight box is cylindrical and is kept in a coaxial position with respect to the through channel by the fastening projection, which fastening projection is radially oriented.

16. The steering device according to claim 3 wherein the watertight box has an inner transversal section with shape and size substantially equal to a transversal section of the motor and an axial length greater than an axial length of the motor, wherein the watertight box is tightly closed by a removable end wall on a side where the motor axle extends, and wherein the removable end wall defines a through opening for the motor axle, and wherein rotation tight means are provided between said through opening and said axle.

17. The steering device according to claim 2, wherein the watertight box comprises a cup shaped element divided into two parts tightly fastenable one to the other.

18. The steering device according to claim 2 wherein the watertight box has an end wall that is removable and tightly fastenable at an end of the watertight box from which the axle extends.

19. The steering device of claim 1, further comprising a second propeller mounted on the axle of the motor in a position opposite to the propeller.

20. The steering device according to claim 3 wherein the watertight box encloses two motors disposed one near the other, wherein the fastening projection defines a single tubular duct, and wherein feeding lines of the two motors pass through the single tubular duct and are shared by both motors.

21. The steering device according to claim 1, wherein the through channel is a tubular channel fastenable on an outside of the hull.

22. The steering device according to claim 21, further comprising means for fastening the through channel to the hull.

23. The steering device according to claim 22, wherein said means enable a movement of the device between an operating position under the water line to an idle position above the water line and viceversa.

24. The steering device according to claim 23 wherein said means comprise a pivotal articulated arm.

25. The steering device according to claim 24, wherein said pivotal articulated arm comprises a projection supporting the motor in the tubular channel, and wherein the projection extends outside said tubular channel.

26. The steering device according to claim 21, wherein the device is configured for boats with a length comprised between 8.5 and 16 meters.

27. The steering device according to claim 21, wherein the tubular channel is made of a fiber reinforced plastic, steel, or aluminum.

28. The steering device according to claim 1 wherein the propeller is made of plastic or synthetic material.

29. The steering device according to claim 1, wherein said motor is 12V power supplied.

30. The steering device according to claim 1, wherein said motor supplies from 0.7 to 1.5 HP.

31. The steering device according to claim 1, wherein an operating current of said motor is 150 Ampere.

32. The steering device according to claim 1, wherein said motor has a motor rotation speed of 4500 rpm.

33. The steering device according to claim 1, wherein the motor weighs between 1.5 and 3 kg.

34. A control system for a steering device for boats having a circuit, the control system comprising:
control/command electronics;
a power relay operatively connecting an electric motor of the steering device with an electric supply source; and
a control/command panel for said steering device,
wherein said control/command electronics receive at least a command signal from said control/command panel for the operation of said device,
wherein said command/control electronics operate said power relay according to said command signal and is configured to close at least an electrical contact of two or more electrical contacts feeding said motor of said steering device, and
wherein said control system provides an operation in safety condition when one of the two or more electrical contacts is in undesired closed condition by causing the other electrical contacts to be closed, thereby causing the circuit to be in an equipotential condition and power supply to the electric motor to be turned off.

35. The control system according to claim 34, wherein said command signal is transmitted by a connection of the bus CAN type.

36. The control system according to claim 34, wherein detection of said undesired closing condition of the one of the two or more electrical contacts is carried out by the command/control electronics following detection of an undesired current passage from the supply source.

37. The control system according to claim 34, wherein detection of said undesired closing condition of the one of the two or more electrical contacts is carried out by the command/control electronics following detection of an undesired or anomalous increase in temperature of the relay and/or motor.

38. The control system according to claim 34, wherein detection of said undesired closing condition of the one of the two or more electrical contacts is carried out by the command/control electronics following detection of an anomalous operating condition detected by one or more sensors.

39. The control system according to claim 34, wherein the control system is operatively connected to a steering device for a boat having a through channel passing through a hull of the boat from side to side under a water line, a propeller being provided inside the through channel the propeller being operated by a motor, wherein said motor is housed inside said through channel, and wherein the propeller is mounted directly on an axle of said motor or is coupled to the motor by a drive placed between said axle of the motor and said propeller.
